(19) United States
(12) Patent Application Publication
(10) Pub. No.: US 2004/0194519 A1
(43) Pub. Date: Oct. 7, 2004

(54) Top-and-bottom latch lock

(76) Inventor: Lynn Chen, Pingtung City (TW)

Correspondence Address: Lynn Chen, P.O. Box No. 6-57, Chung-Ho, Taipei 235, TW

(21) Appl. No.: 10/406,193

(22) Filed: Apr. 4, 2003

(51) Int. Cl. E05B 59/00; E05B 63/14

(52) U.S. Cl. 70/110

(57) ABSTRACT

A top-and-bottom latch lock includes symmetrical L-shaped control rods provided with pressing portions for connecting to springs. The ends of the control rods are disposed with braking pieces provided with bumps, so as to have symmetrical gulfs of a flat member accommodate the bumps of the braking pieces. Above and below the flat member are provided with a turning axis having an opening and an oscillating shaft, respectively, such that the control rods are extended outward or contracted inward through turning of a rotation body, key or handles of the lock, thereby locking or opening a door.

### BACKGROUND OF THE INVENTION

(a) Field of the Invention

The invention relates to a top-and-bottom latch lock, and more particularly, to a top-and-bottom latch lock having simple assembly and smooth operation.

(b) Description of the Prior Art

During the recent years, owing to changes of architectural structures, directions for opening doors have transformed from in-and-out to left-and-right in order to decrease excess areas needed when opening the doors. Therefore, conventional locks consequently have become unsuitable for sliding doors, and top-and-bottom latch locks locked by vertically moving up and down are required. However, common top-and-bottom latch locks have difficult designs for that the latches are pushed vertically up and down, and hence operations thereof may appear rather strenuous and hardly count as being smooth.

### SUMMARY OF THE INVENTION

Therefore, the primary object of the invention is to provide a top-and-bottom latch lock having simple assembly as well as more smooth and effort-saving operations.

The aforesaid lock structure comprises symmetrical L-shaped control rods, pressing portions disposed at the controls rods for connecting to springs, braking pieces disposed at ends of the control rods and provided with bumps, and a flat member having symmetrical gulfs for accommodating the bumps of the braking pieces, such that when a rotation body is turned, the control rods of the lock structure extend outward or contract inward with coordination of the tension of the springs, thereby locking or opening a door.

The aforesaid lock structure further comprises an open axis disposed above the flat member, and for driving a key to rotate in forward and reverse directions for further impelling the rotation body, thereby locking or opening the lock using a key.

The aforesaid lock structure further comprises an oscillating shaft provided below the flat member and pressed against by a Y-shaped axis. The Y-shaped axis is pivotally connected to handles of the lock structure, such that the control rods are displaced in upward and downward directions through impelling of the oscillating shaft, thereby opening or locking the lock.

### BRIEF DESCRIPTION OF THE DRAWINGS

FIG. 1 shows an elevational schematic view according to the invention.

FIG. 2 shows another elevational schematic view according to the invention.

FIG. 3 shows a structural schematic view according to the invention.

FIG. 4 shows a schematic view for illustrating movements of the rotation body in an embodiment according to the invention.

FIG. 5 shows another schematic view for illustrating movements of the rotation body in an embodiment according to the invention.

FIG. 6 shows a schematic view for illustrating locking and opening using a key in an embodiment according to the invention.

FIG. 7 shows another schematic view for illustrating locking and opening using a key in an embodiment according to the invention.

FIG. 8 shows a schematic view for illustrating a handle being used for opening or locking in an embodiment according to the invention.

FIG. 9 shows a schematic view for illustrating a handle being used for opening or locking in another embodiment according to the invention.

### DETAILED DESCRIPTION OF THE PREFERRED EMBODIMENTS

To better understand the characteristics and novelties of the invention, descriptions shall be given with the accompanying drawings hereunder.

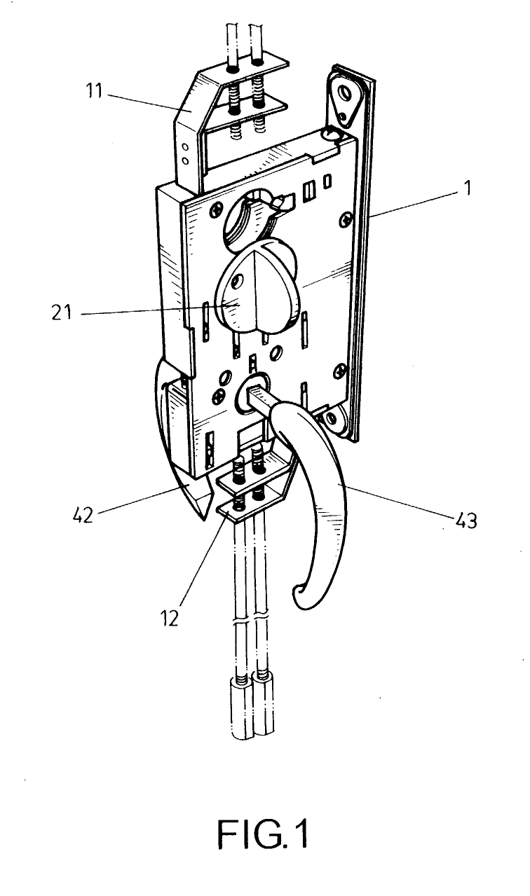

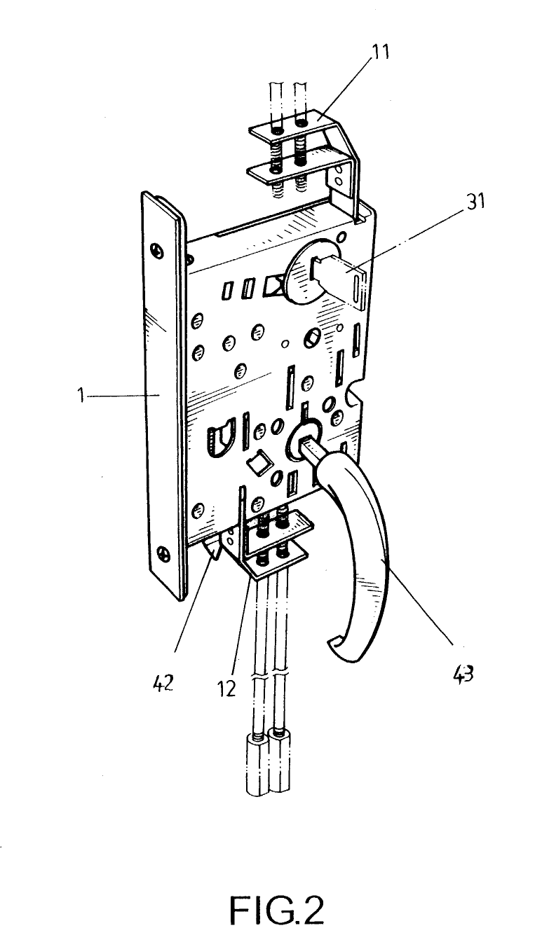

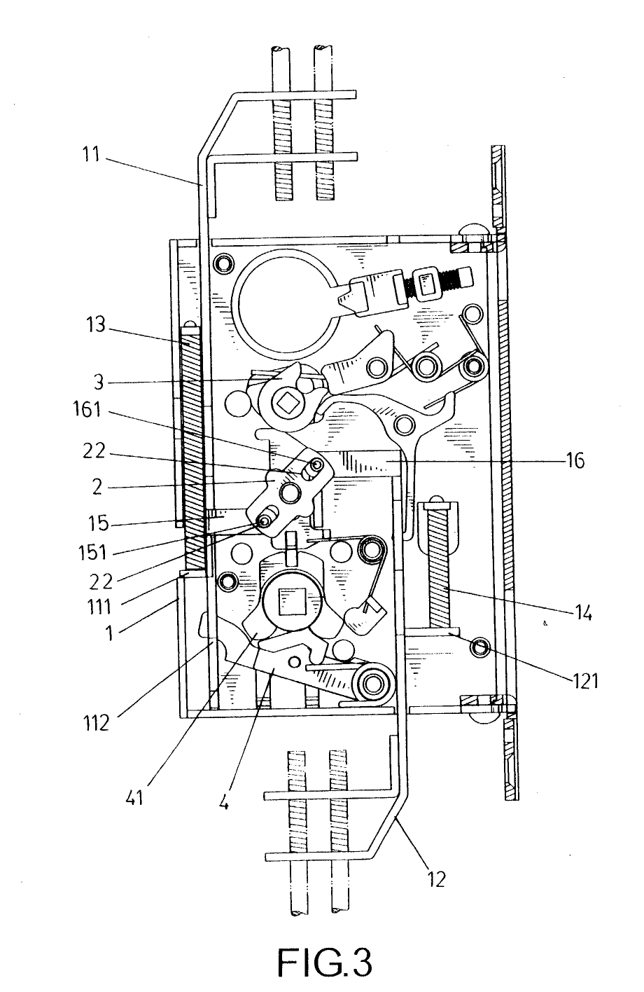

Referring to FIGS. 1, 2 and 3 showing elevational and structural schematic view according to the invention, the invention comprises:

a main body 1 disposed with symmetrical L-shaped control rods 11 and 12, pressing portions 111 and 121 disposed at the control rods 11 and 12 and for connecting to springs. 13 and 14, an indenture 112 provided at the control rod 11, braking pieces 15 and 16 disposed at the ends of the control rods 11 and 12, respectively, and bumps 151 and 161 provided at the braking pieces 15 and 16;

a semi-circular flat member 2 for pivotally connecting to a rotation body 21 at the exterior of the lock structure, and provided with a gulf 22 at the two sides thereof, respectively; wherein the two gulfs 22 are for accommodating the bumps 151 and 161 provided at the braking pieces 15 and 16 of the control rods 11 and 12, such that the control rods 11 and 12 extend upward or downward or contract inward from the lock structure 1 when the bumps 151 and 161 are impelled by turning the rotation body 21, thereby locking or opening a door; an open turning axis 3 disposed above the flat member 2 and connected with a keyhole of the main body 1, so as to displace the control rods 11 and 12 in upward and downward directions due to pushing or pulling forces imposed upon the flat member 2 by the axis turning axis 3 when a key 31 is turned in the keyhole thereof; and

an oscillating shaft 4 disposed below the flat member 2 for pressing against a Y-shaped axis 41 pivotally connected to inner and outer handles 42 and 43 of the main body 1; wherein the front end of the oscillating shaft 4 is inserted and fastened to the indenture 112 of the control rod 11, so that the flat member 2 is relatively impelled by the pulling force imposed upon the control rod 11 by the oscillating shaft 4 when the handle 42 or 43 is turned, thereby contracting the control rods 11 and 12 for opening or extending upward or downward for locking.

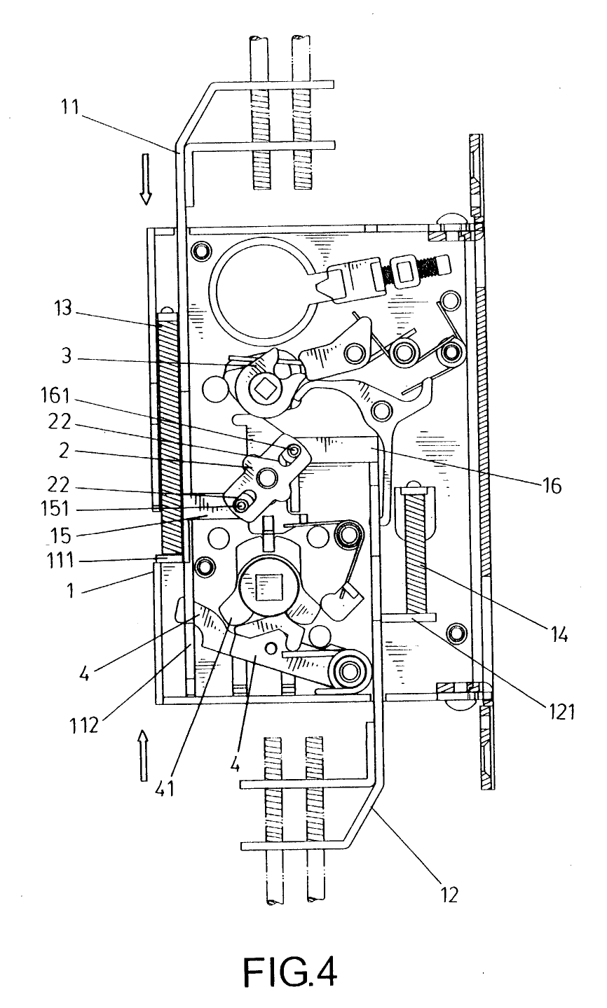

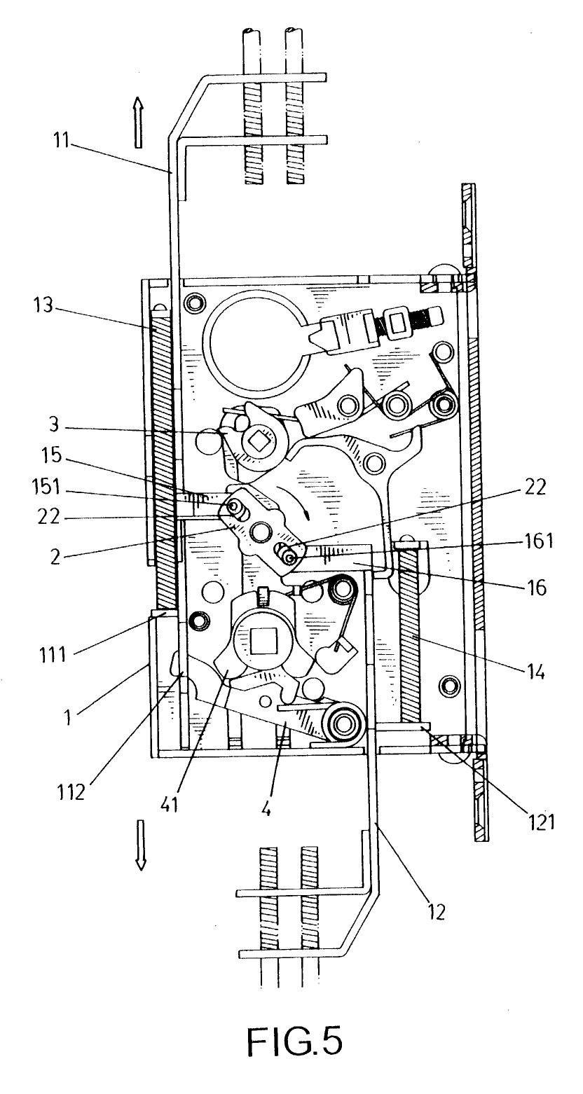

Referring to FIGS. 4 and 5 showing schematic view for illustrating movements of the rotation body in an embodiment according to the invention, wherein when the rotation body 21 is turned, the flat member 2 is impelled such that the gulfs 22 also impel the bumps 151 and 161 at the control rods 11 and 12, thereby displacing the control rods 11 and 12 in upward and downward directions for locking or opening of the lock structure.

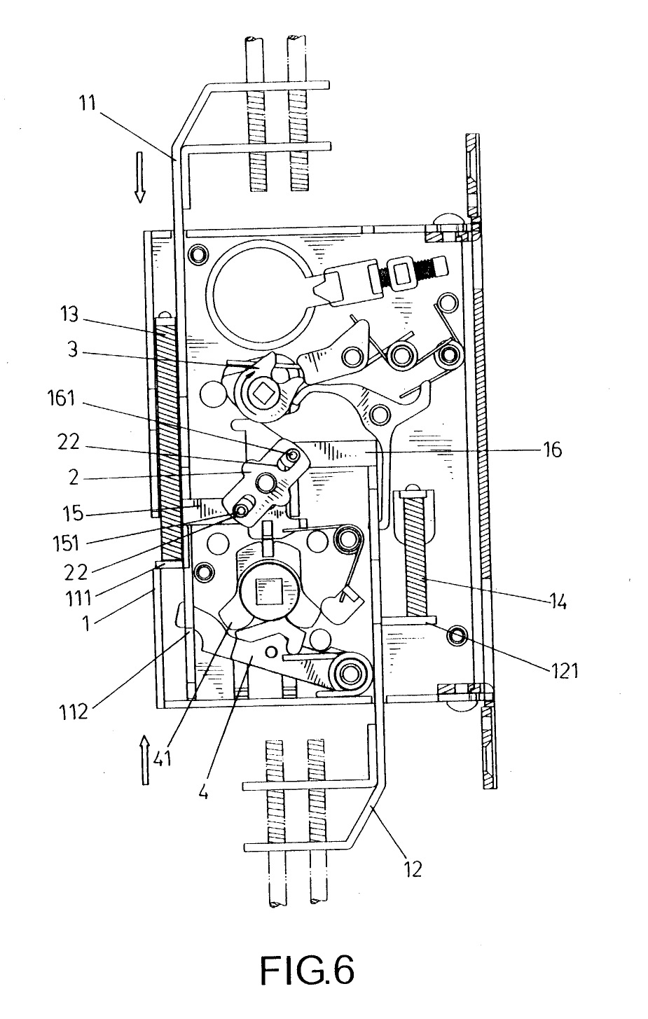

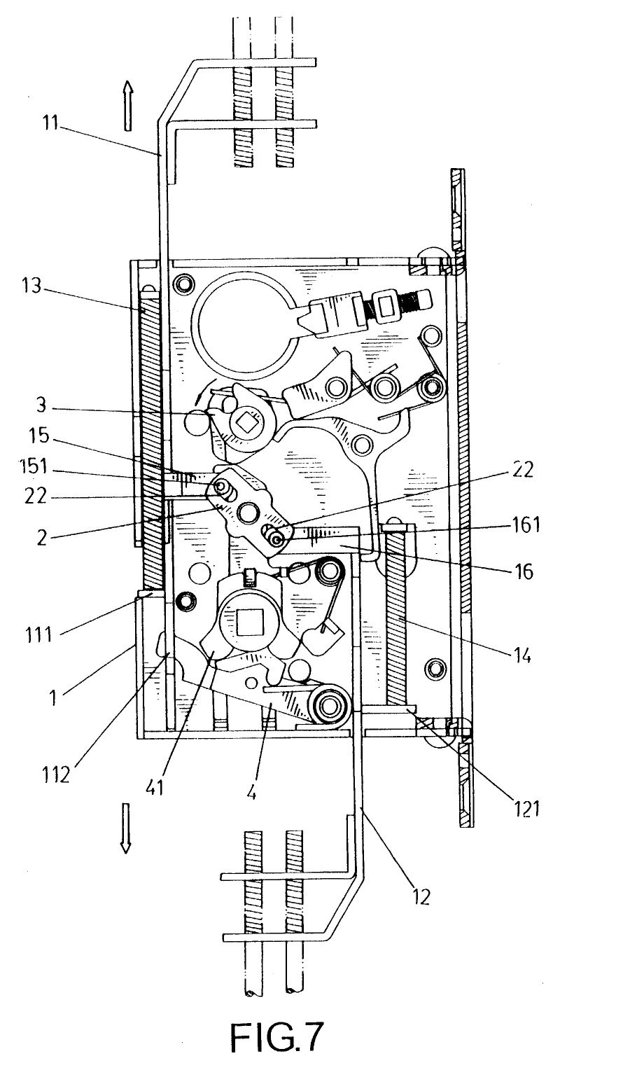

Referring to FIGS. 6 and 7 showing schematic view for illustrating locking and opening using a key in an embodiment according to the invention, wherein the turning axis 3 is turned when using the key 31 for opening, so that pushing or pulling forces are imposed upon the flat member 2, thereby extending or contracting the control rods 11 and 12 in upward and downward directions by impelling of the flat member 2 for opening and locking of the lock structure.

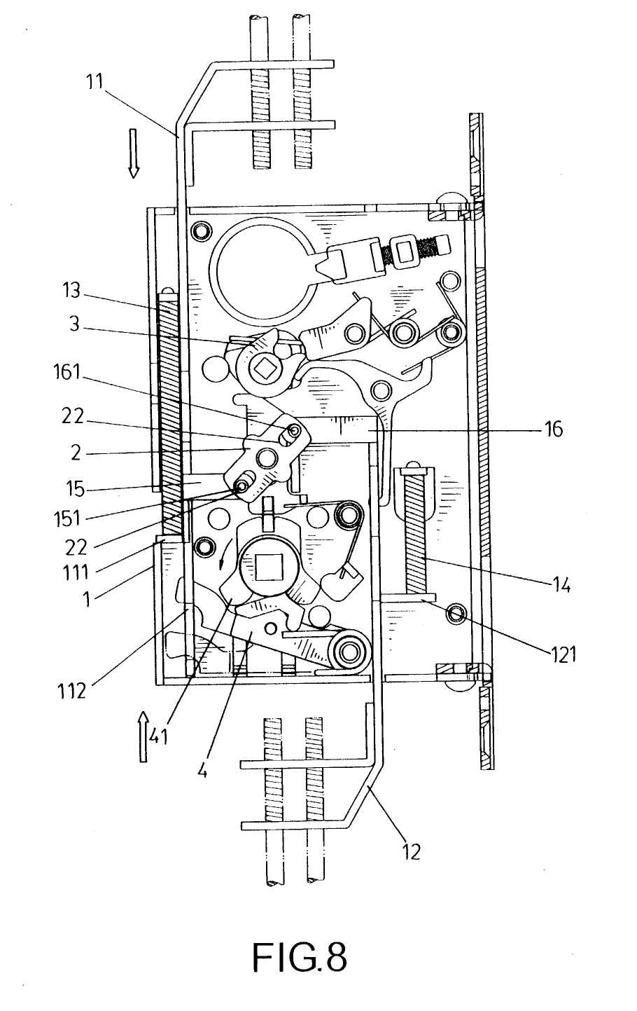

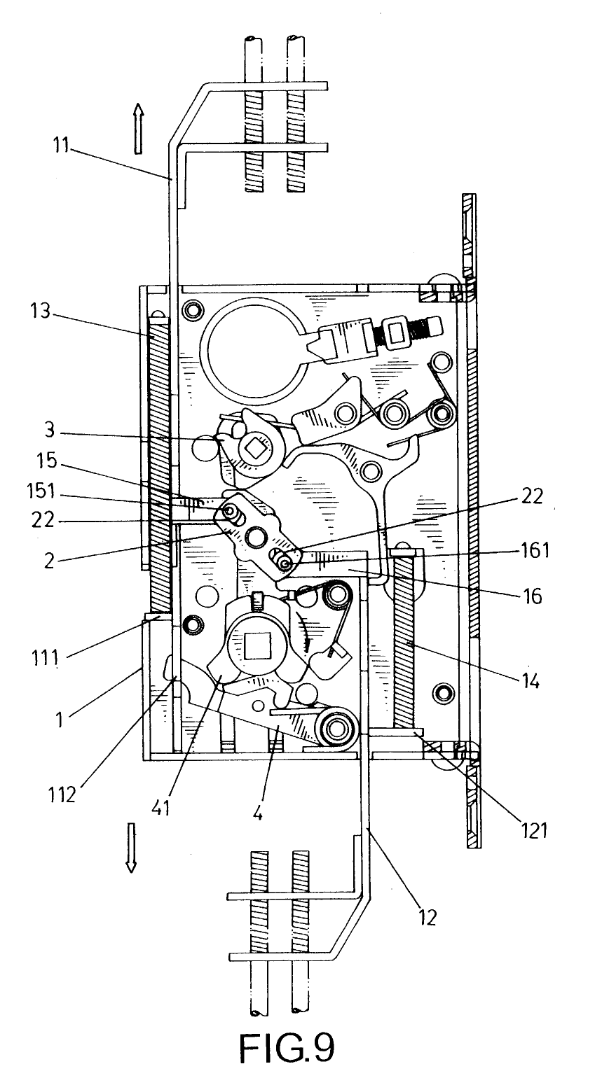

Referring to FIGS. 8 and 9 showing schematic views for illustrating a handle being used for opening and locking in an embodiment according to the invention, wherein the U-shaped axis 41 is rotated when turning the inner or outer handles 42 and 43, and thus pressing against or slackening the oscillating shaft 4. When pressing against the oscillating shaft 4, the control rod 11 is impelled and extended downward by the oscillating shaft 4, and relatively impelling the control shaft 12 through the flat member 2, thereby forming movements for locking. Vice versa, when slackening the oscillating shaft 4, the control rods 11 and 12 are contracted through the reverse rotation of the flat member 2, thereby accomplishing movements for opening.

Conclusive from the above, the flat member having gulfs according to the invention, in coordination with control rods provided with springs, enable the top-and-bottom latch lock to have easy assembly capable of smooth operations. It is of course to be understood that the embodiment described herein is merely illustrative of the principles of the invention and that a wide variety of modifications thereto may be effected by persons skilled in the art without departing from the spirit and scope of the invention as set forth in the following claims.

What is claimed is:

1. A top-and-bottom latch lock comprising:
two L-shaped control rods disposed with pressing portions at an appropriate location at the centers thereof for connecting to springs, respectively, and a braking piece disposed at the ends of the control rods, respectively, wherein one of the control rods is provided with an indenture;
a flat member for pivotally connecting to a rotation body at the exterior of the lock, and provided with a gulf at the two bottom sides thereof, respectively, wherein the two gulfs are for accommodating the bumps provided at the control rods;
a turning axis disposed above the flat member and an opening provided thereof connected with a keyhole of a main body;
an oscillating shaft disposed below the flat member for pressing against a Y-shaped axis pivotally connected to inner and outer handles of the main body, and the front-end thereof inserted and fastened to the indenture of the control rod; and
using the combination of the aforesaid members, the flat member is turned at different directions when turning the rotation body, handles or keyhole, thereby impelling the control rods to extend or contract in upward and downward directions for closing or opening of the top-and-bottom latch lock.
